(19) United States
(12) Patent Application Publication
(10) Pub. No.: US 2022/0241623 A1
(43) Pub. Date: Aug. 4, 2022

(54) RESPIRATOR AND METHODS OF USE

(71) Applicant: AUSTIN BREATHE PROJECT, PBC, Austin, TX (US)

(72) Inventors: Kyle ELLISON, Austin, TX (US); Michelle FRENCH, Austin, TX (US); Shahram SHAFIE, Austin, TX (US); Anand RAGHUNATHAN, Austin, TX (US); Shahab SASSAN, Austin, TX (US)

(73) Assignee: AUSTIN BREATHE PROJECT, PBC, Austin, TX (US)

(21) Appl. No.: 17/591,265

(22) Filed: Feb. 2, 2022

Related U.S. Application Data
(60) Provisional application No. 63/144,524, filed on Feb. 2, 2021.

(51) Int. Cl. A62B 23/02; A62B 18/02; A62B 7/10; A41D 13/11

(52) U.S. Cl. CPC A62B 23/025; A62B 18/025; A41D 13/1138; A41D 13/1161; A62B 7/10

(57) ABSTRACT

A respirator includes a mask shell, a face flange attached to a rear edge of the mask shell, a filter cover removably attachable to the mask shell, a filtration media removably secured between the filter cover and the mask shell, and scannable identification device.

### CROSS-REFERENCE TO RELATED APPLICATION

This application claims priority benefit of U.S. provisional application 63/144,524, filed on Feb. 2, 2021, the contents of which are incorporated herein by reference in their entireties.

### FIELD OF THE DISCLOSURE

This disclosure relates to a sterilizable respirator with replaceable filtration media, recyclable polymer material, and a scannable tracking device and methods of using a respirator.

### BACKGROUND

Respirators filter air and protect individuals from harmful airborne substances. Typically, medical and industrial grade N95 filtering particulate respirators are either disposable and in some cases reusable, with disposable respirators being most commonly used. Most reusable respirators include multiple components, some of which may be reused, some of which may be replaced at regular intervals, and some of which may be sterilized between uses. These reusable respirators typically filter inhalation air but not exhalation air. In the case where the user has contracted an infectious disease, the exhalation air is not filtered and exposes the airborne pathogen to their surroundings. The disposable and reusable respirators cannot be recycled and end up in medical and municipal waste. In the case of the disposable respirators, the long-term use of these devices cause pressure ulcers, facial bruising, and sore ears due to the limited time that the respirator is expected to be used. In the event of a crisis such as a pandemic, these respirators are reused for long period periods of times, for weeks on end, against the manufacturer's recommendations.

### SUMMARY OF THE INVENTION

In one aspect, the present disclosure provides a respirator including a mask shell; a face flange attached to the mask shell and configured to be conformable to a user's facial contours; a filter cover secured with a hinge mechanism or removably attached to an edge of the mask shell; a filtration media secured between the filter cover and the mask shell; one or more strap attachments with one or more straps removably attachable to the mask shell; a scannable identification device; and a sterilization visual indicator.

In some aspects, the identification device comprises a radio-frequency identification device or barcode. In some aspects, a respirator may include at least one strap removably attached to the mask shell. In some aspects, a respirator may have an upper strap and a lower strap. In some aspects, a mask shell can further include at least two snap-on connection tabs and the at least one strap is removably attached to the at least two snap-on connection tabs projecting from the mask shell. In some aspects, a respirator may include a face flange attached to an edge of the mask shell and composed of a flexible material configured to substantially conform to an individual's face contour when the respirator is worn by the individual.

In some aspects, a respirator may include a face flange in attached to an edge of the mask shell and composed of a flexible material configured to substantially conform to an individual's face geometry when the respirator is worn by said individual.

In some aspects, the mask shell can include an outer frame and a mask shell grill. In some aspects, the mask shell grill may include a peripheral flange that is recessed with respect to a front edge of the mask shell, and wherein the filter cover is configured to be seated within the recess of the peripheral flange when attached to the mask shell.

In some aspects, the mask shell may be made from one or more materials selected from the group consisting of medical grade polypropylene (PP), acetal Plastic, Acrylonitrile Butadiene Styrene (ABS), Acetal Copolymer, and engineered thermoplastic polyurethanes (ETPU). In some aspects, the face flange may be made from one or more materials selected from the group consisting of medical grade thermoplastic, Thermoplastic polyurethane (TW), polyurethanes, polyethylene terephthalate polyester (PET-P), and polytetrafluoroethylene (PTFE).

In some aspects, the present disclosure includes a method of sterilizing the respirator of any one of claims 1-13, comprising the steps of exposing the respirator to ozone gas, ultraviolet germicidal irradiation (UVGI), vaporized hydrogen peroxide, dry hydrogen peroxide, steam, or a combination thereof. In some aspects, the method includes performing the sterilizing step such that the respirator has a sterility assurance level (SAL) of 10⁻³, 10⁻⁴, or 10⁻⁶.

In some aspects, the present disclosure includes a method of using a respirator that includes a mask shell; a filter cover secure with a hinge mechanism or removably attached to the mask shell; a filtration media secured between the filter cover and the mask shell; at least one head strap; and a scannable identification device, wherein the method comprises:

at predefined time intervals, opening the filter cover, and replacing the filtration media with a new filtration media before closing the filter cover; and

using the scannable identification device to track one or more of:
a location of the respirator;
an inventory of respirators;
time since the respirator was sterilized;
length of time the respirator was worn each time and since manufacturing;
time since the filtration media was replaced; and
number of total cycles that the respirator has been sterilized.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 is a first exploded, perspective view of the respirator and its components.

FIG. 2 shows perspective views of the respirator and its components showing a method of inserting a filtration media.

FIG. 3 is a second exploded view of the respirator showing an open filter cover and the filtration media.

FIG. 4 is a perspective view of the respirator with the filter cover open and showing the insertion of the filtration media.

FIG. 5 is a front view of the respirator.

FIG. 6 is a front perspective view of the respirator.

FIG. 7 is a rear view of the respirator.

FIG. 8 is a rear perspective view of the respirator.

FIG. 9 is a cross-sectional view along center-line A-A of FIG. 5.

FIG. 10 is a perspective view of the respirator with the filter cover open and showing the filter cover joined using a hinge mechanism.

FIG. 11 shows perspective views of the respirator and its components showing a method of inserting a filtration media joined using a hinge mechanism to operate the filter cover.

FIG. 12 is an exploded, perspective view of the respirator and its components adjustable retention straps that pass through recesses molded into the side portions of the respirator mask shell.

FIG. 13 is a perspective view of the respirator of FIG. 12.

FIG. 14 is a detailed view of FIG. 13 showing how the adjustable retention straps are assembled with the mask shell.

### DETAILED DESCRIPTION

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, etc., are used for convenience in referring to such component, apparatus, location, feature, or a portion thereof or movement, force, or other dynamic action in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, hinged, linked, coupled, or similar terms or variations of such terms, shall encompass both a direct relationship in which the first component, structure, or portion thereof is in direct contact with the second component, structure, or portion thereof and an indirect relationship in which there are one or more intervening components, structures, or portions thereof between the first component, structure, or portion thereof and the second component, structure, or portion thereof.

Furthermore, unless otherwise stated, any specific dimensions mentioned in this description are merely representative of an exemplary implementation of a device embodying aspects of the disclosure and are not intended to be limiting.

To the extent used herein, the term “about” applies to all numeric values and terms indicating specific physical orientations or relationships such as horizontal, vertical, parallel, perpendicular, concentric, or similar terms, specified herein, whether or not explicitly indicated. This term generally refers to a range of numbers, orientations, and relationships that one of ordinary skill in the art would consider as a reasonable amount of deviation to the recited numeric values, orientations, and relationships (i.e., having the equivalent function or result) in the context of the present disclosure. For example, and not intended to be limiting, this term can be construed as including a deviation of ±10 percent of the given numeric value, orientation, or relationship, provided such a deviation does not alter the end function or result of the stated value, orientation, or relationship. Therefore, under some circumstances as would be appreciated by one of ordinary skill in the art a value of about 1% can be construed to be a range from 0.9% to 1.1%.

To the extent used herein, the term “adjacent” refers to being near (spatial proximity) or adjoining. Adjacent objects can be spaced apart from one another or can be in actual or direct contact with one another. In some instances, adjacent objects can be coupled to one another or can be formed integrally with one another.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

This disclosure relates to a reusable and sterilizable respirator with replaceable filtration media, recyclable polymer materials, and a scannable tracking device and methods of using a respirator. The respirator may be made of medical grade polymers which are recyclable and can be reused to produce other plastic products instead of disposing to the medical or municipal waste stream. This characteristic makes the respirator a sustainable product with circular economy compliance. The respirator may be designed and manufactured to meet the medical and construction grades National Institute for Occupational Safety and Health (“NIOSH”) standards and capable of sterilization with different methods. A soft, facial interface flange portion of the respirator is designed to ergonomically conform to various facial structures and contours to create optimal sealing. The lifecycle of the respirator is at least 200 times or more. The filter media may be capable of removing infectious pathogens, including viruses and solid particulate matters from the air with at least the same level as N95 face masks or higher. Examples of these infectious pathogens are severe acute respiratory syndrome (SARS), including, but not limited to MERS-CoV, SARS-CoV, SARS-CoV-2, 229E, NL63, OC43, HKU1, Rhinoviruses3, Influenza viruses (e.g., type A, type B, H1N1, etc.), Varicella viruses, Measles virus, Mumps virus, Hantavirus, Viral meningitis. The filter media can be sterilized and reused multiple times. This reusable respirator filters inhalation and exhalation air, thereby protecting both the user and their surroundings from airborne infectious pathogens. The respirator contains a scannable tracking device that supports supply chain and inventory management at a local and national level near real-time which is a crucial piece of information during crises, such as a SARS-CoV-2 pandemic.

Referring to the figures, a respirator as described herein includes a mask shell 3, a filter cover 2, a filtration media 1 secured between the mask shell 3 and the filter cover 2, a face flange 4 connected to the mask shell 3, an upper head strap 6, and a lower head strap 7, and snap-on strap attachments 5 for attaching the upper strap 6 and the lower strap 7 to the mask shell 3. Additionally, the respirator may include a scannable identification (tracking) device 8 incorporated into a portion of the respirator as well as biological or chemical sterilization indicators on the respirator and filtration media that visually confirms the sterilization process has been performed.

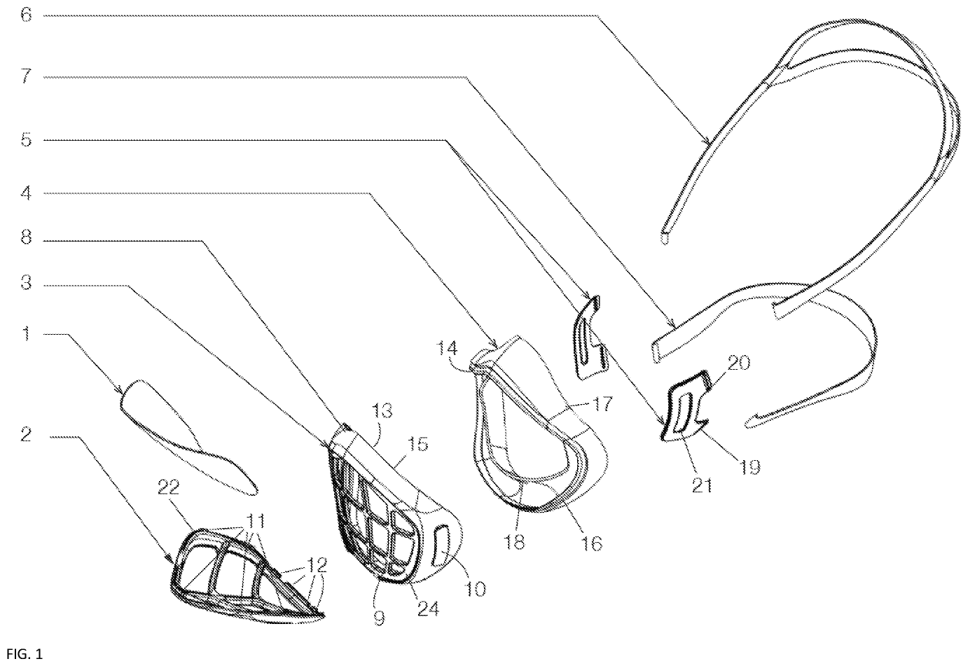

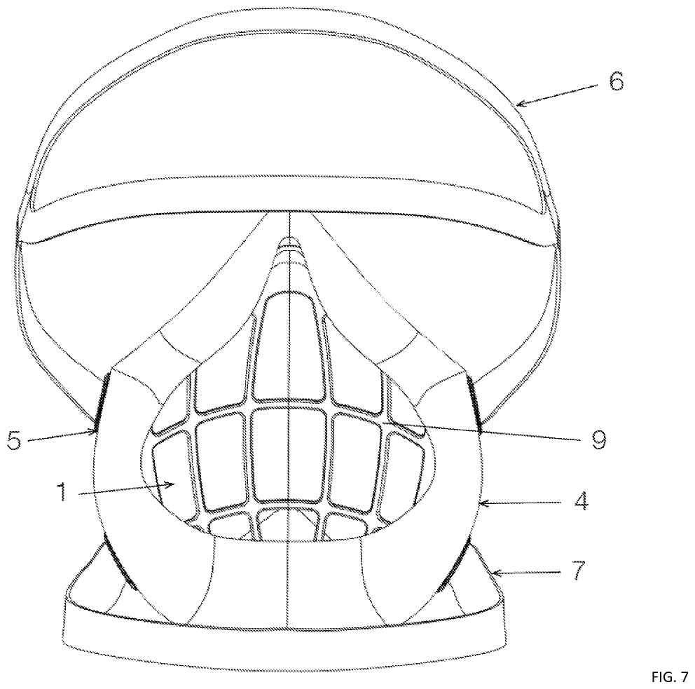

Referring to FIGS. 1, 3, 4, 7, and 10 mask shell 3 is defined by an outer frame 15 and a mask shell grill 9. Grill 9 includes a peripheral flange 24 that extends inwardly from outer frame 15 and is recessed from a front edge of the frame 15 and intersecting horizontal and vertical bars extending from the flange 24 across the mask shell 3. Snap-on connection tabs 10 project from opposed sides of the outer frame 15.

Mask shell 3 may be made of a rigid or semi rigid material, such as injection or compression molded plastic. The material is preferably sustainable and recyclable, is compatible with materials of other components of the respirator, and is capable of sterilization through different methods. Suitable materials include, but are not limited to, medical grade polypropylene (PP), for example available from Westlake Plastics (Lenni Pa., USA; Tourcoing, France), acetal Plastic from Dupont (Wilmington, Del., USA). Other preferred medical grade polymers are Acrylonitrile Butadiene Styrene (ABS), Acetal Copolymer, engineered thermoplastic polyurethanes (ETPU).

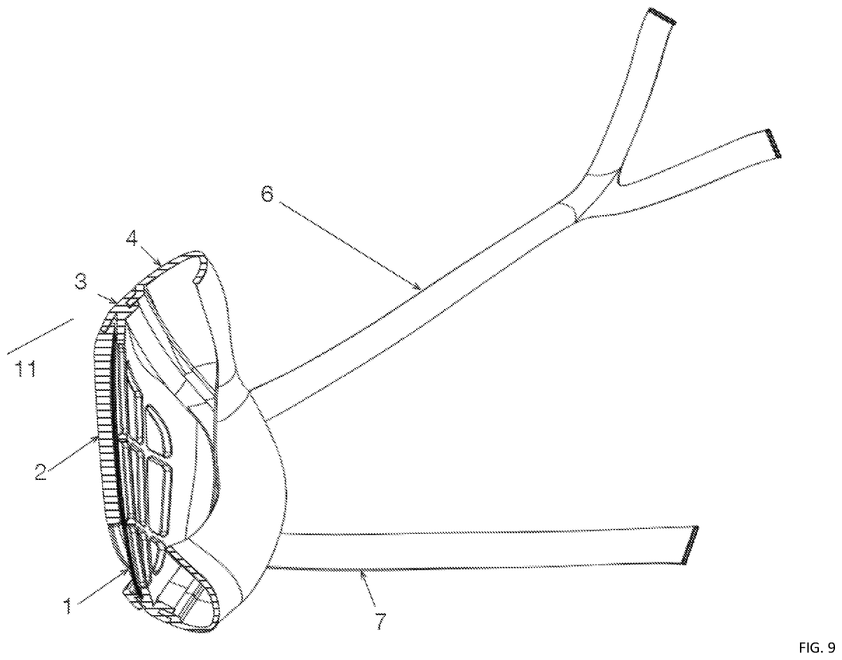

Referring to FIGS. 1 and 9, face flange 4 has a front portion, or outer edge, 16, with a forwardly-facing flange 14 that is received within a peripheral groove 13 of mask shell 3. Face flange 4 may be separately molded with peripheral flange 14, and face flange 4 may be attached to mask shell 3 by inserting peripheral flange 14 of face flange 4 into peripheral groove 13 of mask shell 3. Alternatively, face flange 4 may be over-molded onto a peripheral edge of mask shell 3, thereby connecting the mask shell 3 and the face flange 4. Face flange 4 is defined by a surrounding wall 17 that is rolled inwardly from outer edge 16 of the face flange 4 to inner edge 18. Face flange 4 may be formed with different sizes and shapes, wherein the differently sized and shaped face flanges may be attached to a single, standard sized mask shell 3, to accommodate different users.

The face flange 4 is made of pliable, soft and semi-soft materials that conforms to a wearer's face over the bridge of the nose, around the sides of the mouth, and over the chin below the lower lip, so as to minimize the amount of inhalation and exhalation that leaks around the sides of the respirator between the face flange 4 and the wearer's face. The material is preferably sustainable and recyclable, is compatible with materials of other components of the respirator, and is capable of sterilization through different methods. Suitable materials include, but are not limited to, medical grade thermoplastic Thermoplastic polyurethane (TPU) for example available from Covestro (Leverkusen, Germany), polyurethanes, available from Providien (San Diego, Carlsbad, Calif., USA). Other preferred medical grade polymers are polyethylene terephthalate polyester (PET-P), polytetrafluoroethylene (PTFE).

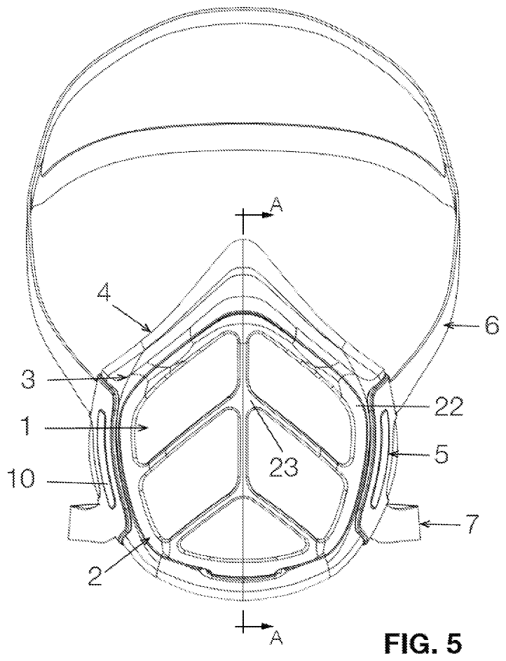

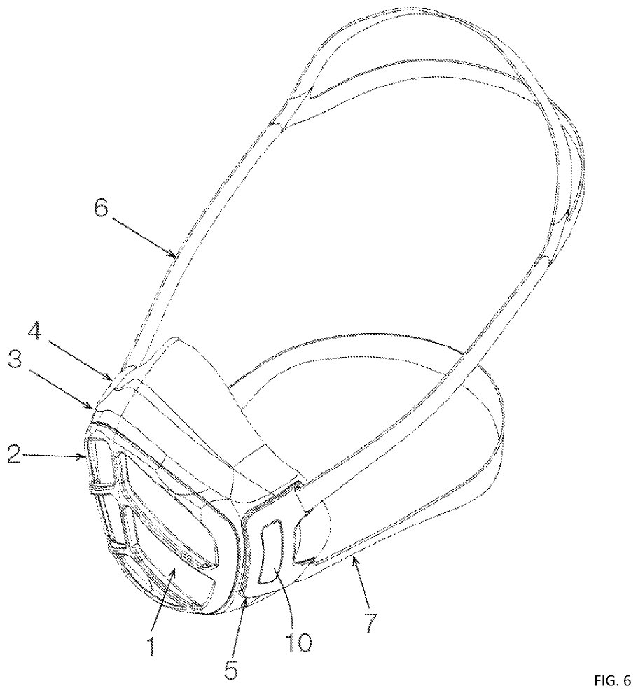

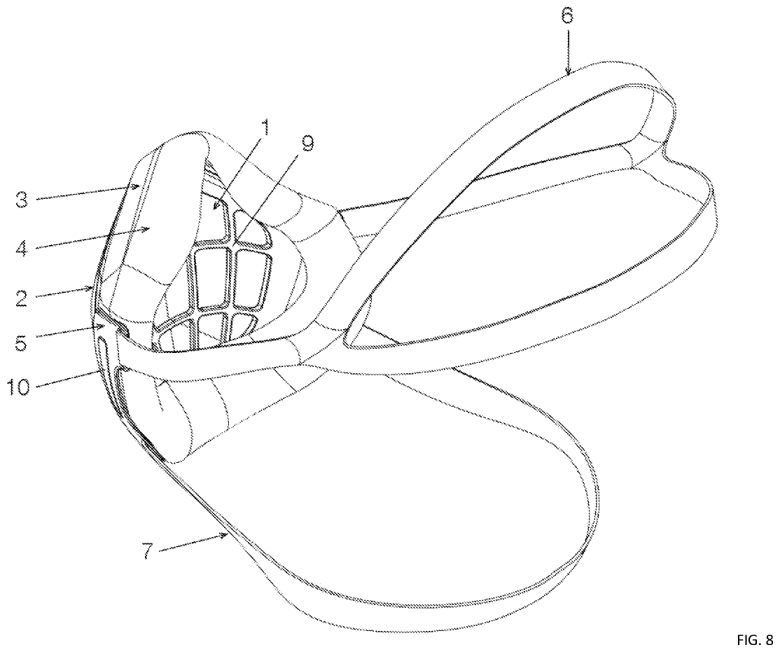

As shown in FIGS. 1 and 3-8, the ends of lower strap 7 are attached at lower attachment points 19 of the strap attachments 5, e.g., by looping the ends of strap 7 through slotted openings at the lower attachment points 19. The ends of upper strap 6 are attached at upper attachment points 20 of the strap attachments 5, e.g., by looping the ends of strap 6 through slotted openings at the upper attachment points 20. Suitable materials for the upper and lower straps are preferably sustainable and recyclable, are compatible with materials of other components of the respirator, and are capable of sterilization through different methods and include, but are not limited to, polyurethane, Thermoplastic polyurethane (TPU) and polypropylene (PP).

As shown in FIG. 1, strap attachments 5 may be connected to the mask shell 3 by snapping the strap attachments 5 onto the snap on connection tabs 10 of the mask shell 3. Each of the strap attachments 5 has formed therein an elongated opening 21 having a size and shape to receive the snap on connection tabs 10 with an interference fit so as to releasably secure the strap attachments 5 to the mask shell 3.

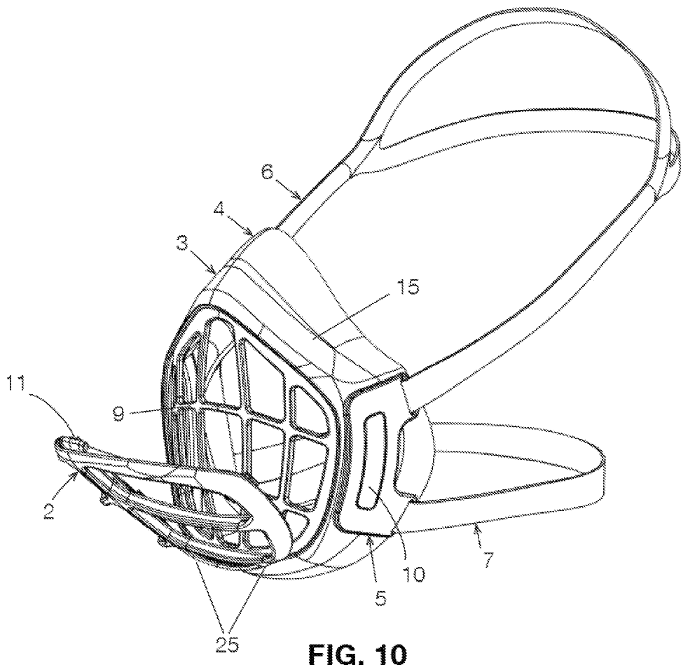

Filter cover 2 is defined by an outer frame 22 and a filter cover grill 23. Outer frame 22 is shaped to conform to the recessed peripheral flange 24 of mask shell 3 so that filter cover 2 is able to seat within the mask shell 3. In one example, as shown in FIG. 1, filter cover 2 further includes upper connecter tabs 11 and lower connector hooks 12 extending from the outer frame 22 for connecting the filter cover to the mask shell 3. In another example, as shown in FIG. 10, filter cover 2 further includes upper connecter tabs 11 and lower connector hinge locksnap extending from the outer frame 22 for connecting the filter cover to the mask shell 3.

Filter cover 2 may be made of a rigid or semi rigid material, such as injection molded plastic. The material is preferably sustainable and recyclable, is compatible with materials of other components of the respirator, and is capable of sterilization through different methods. Suitable materials include, but are not limited to, medical grade polypropylene available from Westlake Plastics (Lenni Pa., USA; Tourcoing, France), acetal Plastic from Dupont (Wilmington, Del., USA). Other preferred medical grade polymers are Acrylonitrile Butadiene Styrene (ABS), Acetal Copolymer, engineered thermoplastic polyurethanes (ETPU) and polypropylene (PP).

Filtration media 1 is a flexible sheet held between the mask shell 3 and the filter cover 2 and supported by the mask shell grill 9 and filter cover grill 23. Filtration media 1 may be made of single or multi-layer non-woven fabrics. The filtration media is preferably sustainable and recyclable, is compatible with materials of other components of the respirator, and is capable of sterilization through different methods. High Efficiency Particulate Air, or as commercially known HEPA, is a class of filter media and the preferred but not limited filtration media. The HEPA filters provides a high filtration efficiency for particulate contaminants, which are 0.3 μm (micron) and sometimes even smaller. The efficiency of HEPA filter can be up to 99.7% which classifies it as high efficiency filtration performance material. HEPA filtration material is widely used in air conditioners, air cleaners, and microelectronic and biosafety lab clean rooms to block and filter the particulates, very small particles, powder dust, and other allergen and pathogens. The HEPA filter is manufactured from various nonwoven fabrics, and the HEPA filter media may be made of different materials, for example, polypropylene or PP filter fabric, fiberglass filter fabric (only use in multi-layer filtration media for this invention), PP and polyethylene terephthalate (PET) composite material and non-woven fabrics. Suitable filter material includes non-woven fabrics including but not limited HEPA filter fabrics such as polypropylene or PP filter fabric, PP and polyethylene terephthalate (PET) and other fabrics that are commonly used for N95 masks. In an embodiment, filter media 1 lacks an exhalation hole formed therein which provides two-way air filtration. There is a visual indicator that is placed on the exterior that verifies sterilization to help ensure the wearer's safety.

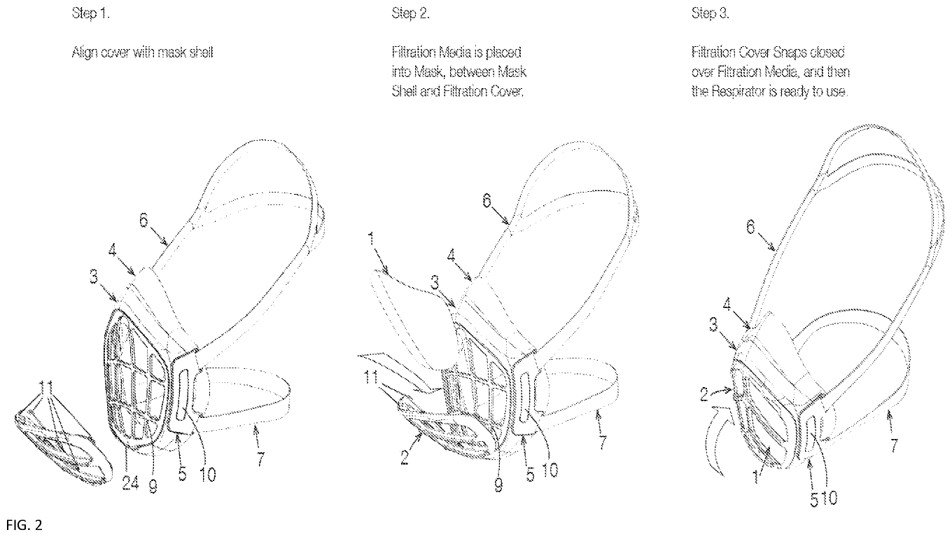

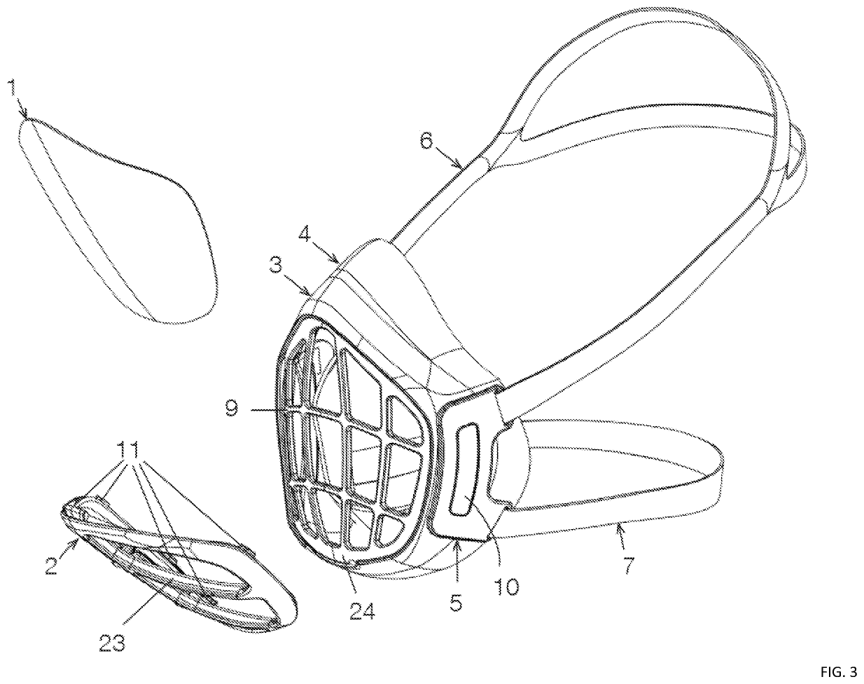

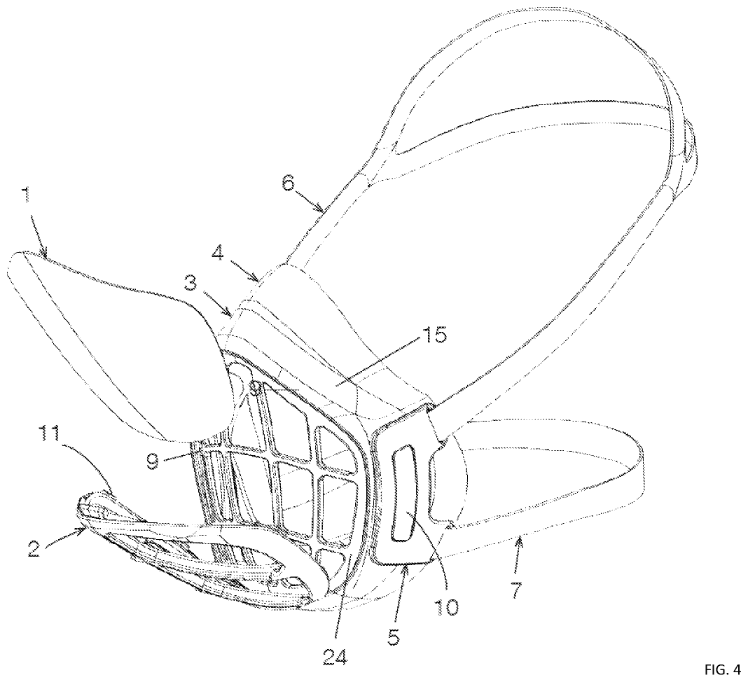

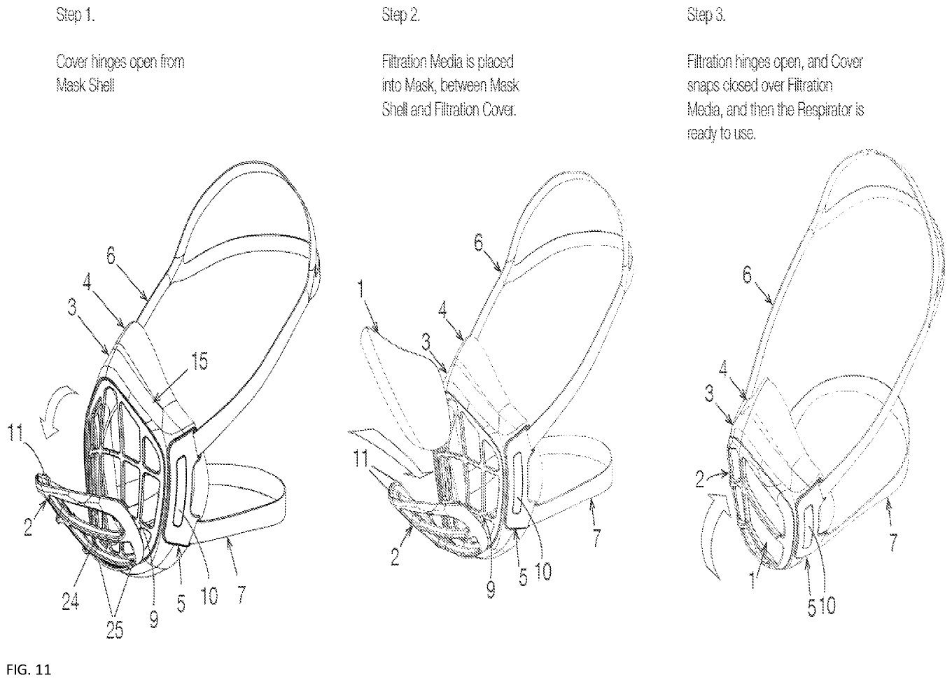

FIGS. 2-4 and 10-11 illustrate a process for securing the filter media 1 between the mask shell 3 and the filter cover 2. In Step 1, as shown in FIG. 2 and FIG. 3, the filter cover 2 is aligned with the mask shell 3, or, as shown in FIGS. 10 and 11, the filter cover is pivoted about hinge 25 to an open position. In Step 2, as shown in FIG. 2 and FIG. 4, lower hooks 12 projecting from the bottom of the filter cover 2 are inserted into corresponding openings (not shown) formed in the lower part of the outer frame 15 of mask shell 3. With lower hooks 12 inserted into openings formed in the outer frame 15, filter cover 2 is able to pivot in a hinge-wise fashion with respect to the mask shell 3. As shown in FIGS. 2 and 11, filtration media 1 is inserted between mask shell 3 and filter cover 2 over the mask shell grill 9 of the mask shell 3. In some embodiments, the outer contour of the filtration media 1 corresponds to the outer contour of grill 9, and the outer periphery of the filtration media 1 overlaps the peripheral flange 24 of mask shell 3. In Step 3, as shown in FIG. 2, 11 with the filtration media 1 placed over the mask shell grill 9, the filter cover 2 is pivoted into a closed position to seat the outer frame 22 of filter cover 2 into the recessed peripheral flange 24 of the mask shell 3. Upper tabs 11 of the filter cover 2 extend into corresponding openings tabs 26 (see FIG. 9) formed in the outer frame 15 of the mask shell 3. Upper tabs 11 may include detent-like features at their terminal ends that releasably lock the upper tabs 11 into the corresponding openings or tabs 26 of the mask shell 3 to hold filter cover 2 in place on the mask shell 3. As noted, the respirator may include a scannable ID tracking device 8, which, in one example, comprises a remotely scannable device, such as a radio-frequency identification (“RFID”) tag embedded in or secured to the mask shell 3. In another example, tracking device 8 may comprise a bar code—e.g., a one-dimensional or two-dimensional bar code—secured to a portion of respirator so as to be scannably accessible to a bar code scanner or other similar scanning or tracking technology. Tracking device 8 may be molded into the mask shell 3, or it may be secured to mask shell 3 by a suitable adhesive.

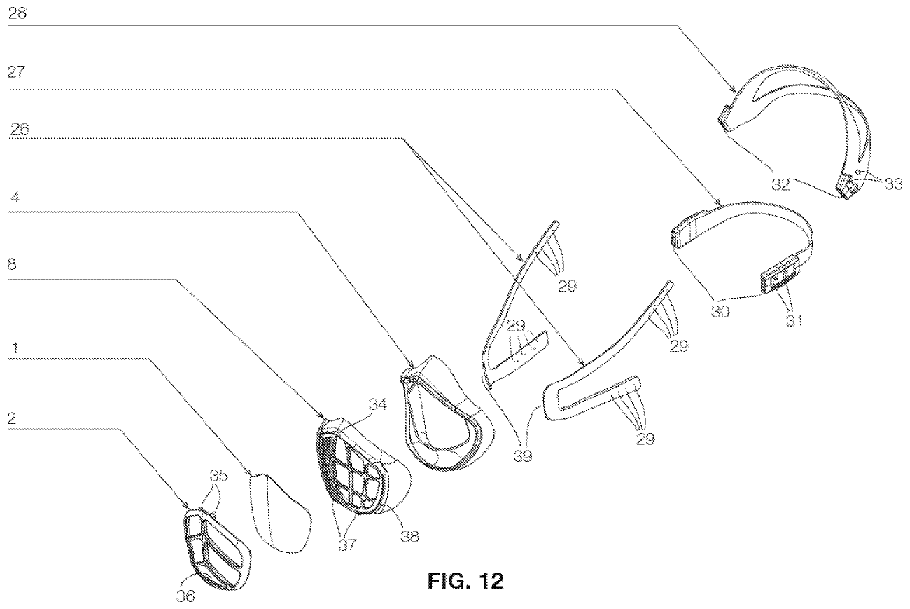

FIGS. 12-14 illustrate the respirator with adjustable retention straps that pass through recesses molded into the side portions of the respirator mask shell. The ends of the adjustable retention straps connect to an upper and a lower retention cradle with adjustable locking geometry. In one instance the upper and lower adjustable retention straps (on each side) are made from one piece. In another instance, these could be 2 separate strap pieces per side with the same functionality.

The adjustable strap ends connect with the upper and lower retention cradles such that they point away from the face, with the strap ends captured by a locking mechanism on the end of each upper and lower retention cradle.

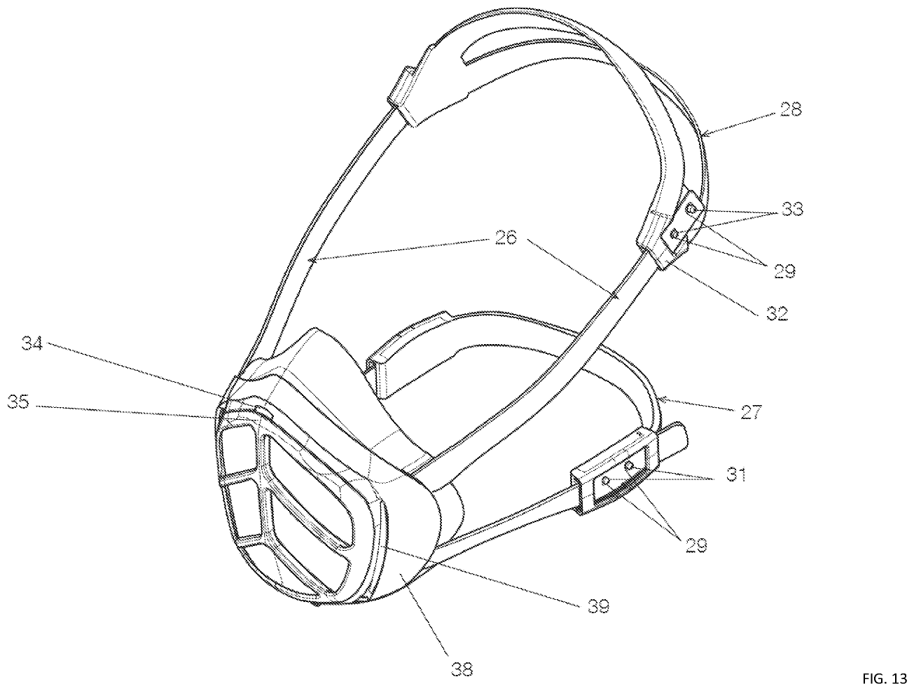

Referring to FIGS. 12 and 13, the cover snap-on hinge geometry 36 and rigid face frame snap-on hinge geometry 37 indicate the snap-on geometry for cover 2 and mask shell 3. The parts snap together to form the exterior of the mask. Respectively, the ergonomic affordance 34 and snap release geometry 35 indicate the geometry required to close and seal the cover 2 over the top of the filtration media 1.

Items 26, 27, 28, 29, 30, 31, 32, 33, and 39 are the features and components of an adjustable, elastomeric retention system for a respirator or face mask type product. Adjustable retention straps 26, which consist of elastomeric straps, with size adjustment holes on the straps 29. The lower retention cradle 27, is designed to work with the complete assembly to hold tension on the lower portion of the mask against the user's face, and the upper retention cradle 28 is designed to hold securely to the top of the head opposing the face to create a complete seal. The lower retention cradle strap lock pins 31 and upper retention cradle strap lock pins 33 are designed to engage with the holes 29 on the adjustable retention straps 26.

The upper and lower retention cradles include specific geometry to work as strap pass throughs, to retain the strap position when assembled with each cradle. These geometries are indicated in FIG. 12 and FIG. 13 as lower retention cradle strap pass-thru 30, and upper retention cradle strap pass-through 32.

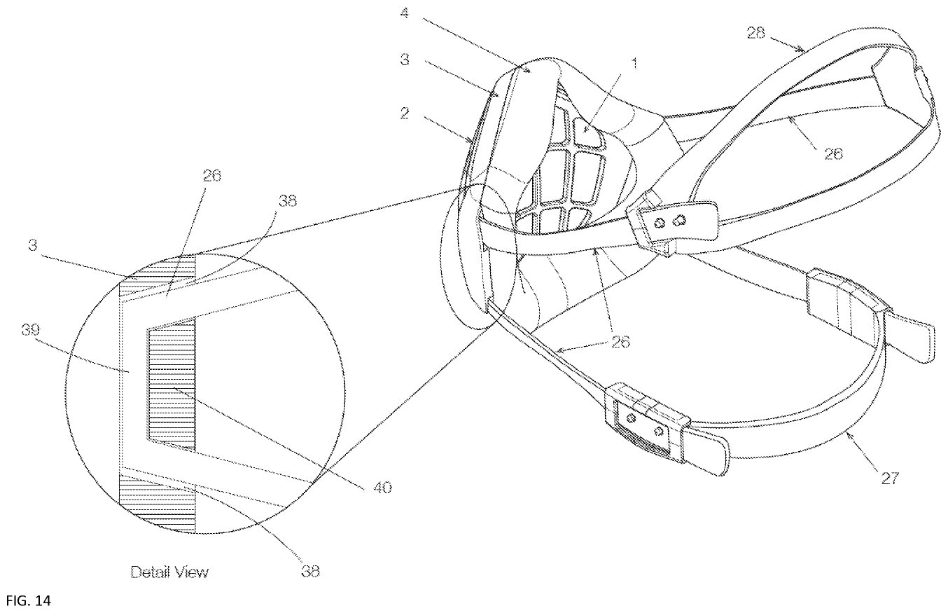

The detailed View in FIG. 14 shows how the adjustable retention straps 26 are assembled with mask shell 3. In this detail the upper and lower arms of the adjustable retention strap 26 are assembled to the mask shell 3 through the pass-through openings 38 for the adjustable retention straps. The Yoke 39, the geometry on the front of adjustable retention straps 26, works with the mask shell 3 locking geometry 40, to secure the adjustable retention straps 26 into place with the mask shell 3 to allow the completed assembly to stay connected together.

The reference numbers are as follows:
26: Adjustable Retention Straps (Left & Right)
27: Lower Retention Cradle
28: Upper Retention Cradle
29: Holes in Strap for Fit Adjustment
30: Lower Retention Cradle Strap Pass Thru
31: Lower Retention Cradle, Strap Lock Pins
32: Upper Retention Cradle Strap Pass Thru
33: Upper Retention Cradle, Strap Lock Pins
34: Ergonomic affordance on Rigid Face Frame for opening Cover
35: Snap Release geometry on Cover to snap securely onto Rigid Face Frame
36: Cover Snap-On Hinge Geometry to mate with Rigid Face Frame
37: Rigid Face Frame Snap-On Hinge geometry to mate with Cover
38: Rigid Face Frame Pass Thru for Adjustable Retention Straps (appears symmetrically on both sides)
39: Adjustable Retention Strap—Yoke with Rigid Face Frame mating geometry
40: Rigid Face Frame Locking Geometry for Adjustable Retention Strap

The respirator may also include a sterilization indicator on the respirator and/or filtration media. The sterilization processing of the respirators will include chemical or biological sterilization indicators that confirm bacterial or viral decontamination. This is dependent on the sterilization process that the respirator undergoes. The indicator method would vary and can include process, multiparameter, or emulating systems. Biological species used as indicators could include, but are not limited to, Geobacillus stearothermophilus spores, Bacillus atrophaeus, E. coli, Brevundimonas diminuta, acute respiratory syndrome (SARS), MERS-CoV, SARS-CoV, SARS-Co-V2, 229E, NL63, OC43, HKU1, Rhinoviruses3, Influenza viruses (type A, type B, H1N1), Varicella viruses, Measles virus, Mumps virus, Hantavirus, and Viral meningitis. The indicators are comprised of tape, self-adhesive strips, printed on the outside of a package, contained within a package, and use various methods to display sterilization results. Examples of the results could be a display of pass/fail, or a visual cue to identify procedural errors and equipment malfunctions. The indicator can be adhered to the mask shell and/or filtration media cartridge.

In one aspect, the respirator comprises adjustable retention straps that pass through recesses molded into the side portions of the respirator mask shell. The ends of the adjustable retention straps connect to an upper and a lower retention cradle with adjustable locking geometry. In one instance the upper and lower adjustable retention straps (on each side) are made from one piece. In another instance, these could be 2 separate strap pieces per side with the same functionality. The adjustable strap ends connect with the upper and lower retention cradles such that they point away from the face, with the strap ends captured by a locking mechanism on the end of each upper and lower retention cradle.

The following is a nonexhaustive list of functions that can be performed using the scannable identification device 8.

In one example, the each respirator would scanned with an scanner, or reader, e.g., an RFID reader, within a storage bin at the user facility level, e.g., hospital. In addition, each respirator would be scanned at a sterilization facility after it is sterilized to confirm the respirator is sterilized and to track the number of sterilization cycles so that the respirator can be removed from use when degradation is such that the respirator is deemed expired. This expiry date would be a definite number based on lifecycle testing to ensure consistent performance. A scannable tag can also be used to conduct physical inventory counts at any given moment, and can be used to assign inventory with certain lot numbers to specific hospital systems. A scannable tag can also be used to track accumulated use time of the respirator, e.g., by scanning the scannable tag at the beginning and end of each shift in which the respirator is worn—January 26: 1 hour, January 27: 3 hours, etc.

A barcode system would work similarly for issuing inventory to particular hospital systems or entities that do not have RFID capability. Used in connection with a network, an individual may scan the scannable identification device 8 before the respirator is cleaned, and the scannable identification device 8 in conjunction with a network may therefore be used to monitor when the respirator is cleaned.

Used in connection with a network, an individual may scan the scannable identification device 8 before the filtration media is replaced 1, and the scannable identification device 8 in conjunction with a network may therefore be used to monitor the last time the filtration media 1 was replaced.

Used in connection with a network, an individual may scan the scannable identification device 8 when the respirator enters an organization's inventory, and the scannable identification device 8 in conjunction with a network may therefore also be used to track respirator inventory for on a variety of scales, ranging from either a single organization (e.g., a hospital) to an entire country.

Alternatively, a bar code and bar code reader may be used for tracking purposes in combination with or in place of an RFID tag.

Used in connection with a network, ownership of the respirator can be tracked to an entity or individual level via a database that correlates each respirator identification number to a particular entity or individual.

The respirator may conform to standards set by the National Institute for Occupational Safety and Health (“NIOSH”) for nonpowered air purifying particulate respirator classification (see, e.g., 42 CFR 84 Subparts G (General Construction and Performance Requirements) and K (Air Purifying Particulate Respirator), which are incorporated herein by reference in their entirety), e.g., one or more of, particle filtration efficiency, bacterial filtration efficiency, liquid barrier penetration, pressure drop, flammability, biocompatibility, and inhalation and exhalation/leakage.

The respirator may be sterilized at certain intervals, such as daily or weekly, depending on the exposure time of the respirator to the pathogens and the local or federal guidelines. In some instances, the companies, institutions or personal preferences might influence the frequency.

Any sterilization method that can eliminate the pathogens while maintaining the regulatory performance standards can be used to sterilize the respirator and the filtration media. Exemplary sterilization methods include ozone gas and ultraviolet germicidal irradiation (UVGI), which is a method of disinfection that uses short wavelength ultraviolet light (UVC). Other exemplary sterilization methods include vaporized hydrogen peroxides and dry hydrogen peroxides, high pressure and temperature steam, and any combination of these methods. In some instances, the recommended sterilization method is high concentration of ozone gas chamber or ozone gas in combination with UVGI light sources. In some examples, sterilization cycles should comply with local or federal regulatory standards and requirements for domestic and international markets. For example, CFR Title 21, Chapter 1, Subchapter F outlines guidelines for manufacturers to establish written procedures for sterility testing.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the scope of the following appended claims.

What is claimed is:

1. A respirator comprising:
a mask shell;
a face flange attached to the mask shell and configured to be conformable to a user's facial contours;
a filter cover secured with a hinge mechanism or removably attached to an edge of the mask shell;
a filtration media secured between the filter cover and the mask shell;
strap attachments with one or more straps removably attachable to the mask shell;
a scannable identification device; and
a sterilization visual indicator.

2. The respirator of claim 1, wherein the identification device comprises a radio-frequency identification device or barcode.

3. The respirator of claim 1, further comprising at least one strap removably attached to the mask shell.

4. The respirator of claim 3, wherein the at least one strap comprises an upper strap and a lower strap.

5. The respirator of claim 1, further comprising at least one adjustable retention strap that passes through recesses molded into side portions of the respirator mask shell.

6. The respirator of claim 5, wherein upper and lower adjustable retention straps on each side of the mask shell are made from one piece.

7. The respirator of claim 5, wherein upper and lower adjustable retention straps on each side of the mask shell are two separate strap pieces.

8. The respirator of claim 3, wherein the mask shell further comprises at least two snap-on connection tabs and the at least one strap is removably attached to the at least two snap-on connection tabs projecting from the mask shell.

9. The respirator of claim 1, further comprising a face flange attached to an edge of the mask shell and composed of a flexible material configured to substantially conform to an individual's face contour when the respirator is worn by said individual.

10. The respirator of claim 1, further comprising a face flange in attached to an edge of the mask shell and composed of a flexible material configured to substantially conform to an individual's face geometry when the respirator is worn by said individual.

11. The respirator of claim 1, wherein the mask shell further comprises an outer frame and a mask shell grill.

12. The respirator of claim 10, wherein the mask shell grill includes a peripheral flange that is recessed with respect to a front edge of the mask shell, and wherein the filter cover is configured to be seated within the recess of the peripheral flange when attached to the mask shell.

13. The respirator of claim 1, wherein the mask shell is made from one or more materials selected from the group consisting of medical grade polypropylene (PP), acetal Plastic, Acrylonitrile Butadiene Styrene (ABS), Acetal Copolymer, and engineered thermoplastic polyurethanes (ETPU).

14. The respirator of claim 1, wherein the face flange is made from one or more materials selected from the group consisting of medical grade thermoplastic, Thermoplastic polyurethane (TPU), polyurethanes, polyethylene terephthalate polyester (PET-P), and polytetrafluoroethylene (PTFE).

15. The respirator of claim 1, wherein the one or more straps are made from one or more materials selected from the group consisting of polyurethane, Thermoplastic polyurethane (TPU) and polypropylene (PP).

16. The respirator of claim 1, wherein the filter cover is made from one or more materials selected from the group consisting of, medical grade polypropylene, acetal Plastic, Acrylonitrile Butadiene Styrene (ABS), Acetal Copolymer, engineered thermoplastic polyurethanes (ETPU) and polypropylene (PP).

17. A method of sterilizing the respirator of claim 1, comprising the steps of exposing the respirator to ozone gas, ultraviolet germicidal irradiation (UVGI), vaporized hydrogen peroxide, dry hydrogen peroxide, steam, or a combination thereof.

18. The method of claim 17, further comprising performing the sterilizing step such that the respirator has a sterility assurance level (SAL) of 10⁻³, 10⁻⁴, or 10⁻⁶.

19. A method of using a respirator that includes a mask shell; a filter cover secure with a hinge mechanism or removably attached to the mask shell; a filtration media secured between the filter cover and the mask shell; at least one head strap; and a scannable identification device, wherein the method comprises:
at predefined time intervals, opening the filter cover, and replacing the filtration media with a new filtration media before closing the filter cover; and
using the scannable identification device to track one or more of:
a location of the respirator;
an inventory of respirators;
time since the respirator was sterilized;
length of time the respirator was worn each time and since manufacturing;
time since the filtration media was replaced; and
number of total cycles that the respirator has been sterilized.
